(19) United States
(12) Patent Application Publication
(10) Pub. No.: US 2008/0256194 A1
(43) Pub. Date: Oct. 16, 2008

(54) Email Bookmark with Automatic Archiving

(76) Inventors: Janice M. Girouard, Austin, TX (US); Robert J. Eggers, Austin, TX (US); Steven F. Best, Georgetown, TX (US)

Correspondence Address: HAMILTON & TERRILE, LLP;IBM Austin, P.O. BOX 203518, AUSTIN, TX, 78720, US

(21) Appl. No.: 11/734,870

(22) Filed: Apr. 13, 2007

(51) Int. Cl. G06F 15/16

(52) U.S. Cl. 709/206

(57) ABSTRACT

An email message content management method, system and program are provided for bookmarking subsets of electronic mail (email) message content for subsequent searching and retrieval. Subsets of email message content are designated and then identified to be bookmarked for subsequent searching and retrieval. Identification information such as file pointers and Uniform Resource Identifier (URI) links identifying the bookmarked email message content are generated and then indexed such that the bookmarked content can be searched. A copy of the email message is then automatically and persistently stored in a predetermined location. The bookmarked email message content can subsequently be retrieved, either by browsing the copies of the stored email messages or by performing search operations.

### BACKGROUND OF THE INVENTION

1. Field of the Invention

The present disclosure relates in general to the field of computers and similar technologies and, in particular, to software utilized in this field. Still more particularly, it relates to the bookmarking and automatic archiving of email message content.

2. Description of the Related Art

Electronic mail (email) has become a fast, reliable, and easy-to-use method of communication. The growing popularity of email has led to an increase in the volume of email messages, which often need to be retained and retrieved at a later time. Some of these messages or their attachments (e.g., binary files such as spreadsheets) need to be retained in their entirety, while others contain a subset of content that the user is interested in saving for later retrieval. Current implementations of email messaging systems generally provide users the ability to store entire email messages and file attachments, often using a directory tree paradigm to file the email messages into folders organized by subject, sender, or other classification. However, locating email messages that contain specific content becomes more challenging for users as the number of stored emails grows. As a result, it is common for current email systems to provide capabilities for locating and retrieving email messages matching search terms or containing key words entered by a user.

However, these approaches typically limit the user to searching for predefined information contained within the email message header or the occurrence of key words in the subject field or body of the email. For example, common search fields include the email's sender, the date it was sent, or its subject line, which often do not contain the user's search criteria and result in too few returned results. Conversely, a full text search may return too many false positive results if the key words used for the search are too general or common. Furthermore, the time to complete full text searches often increases proportionally to the number of email messages being searched, the search terms being applied, and the number of key words being used. Other email content search approaches allow the use of Boolean operators and exact text phrasing to narrow the scope of the search and the number of returned results. However, these approaches require the user to be trained in their use or to be able to provide the search phrase exactly as it is within the email message content.

While these approaches can assist users in locating and retrieving entire email messages that match search terms or contain key words, they do not facilitate the location and retrieval of subsets of email message content. This inability creates issues when the user is searching for a subset of content that is a small part of the total email message. Other content indexing and search approaches, such as bookmarklets and plug-ins for Adobe Acrobat, exist for retrieving subsets of digitized content such as web pages, but they do not provide the same capabilities for email message content. Furthermore, email messages and the content subsets they contain are often automatically deleted unless the user acts proactively to save the message in a back-up folder, further hindering the user's content retrieval efforts.

### BRIEF SUMMARY OF THE INVENTION

An email message content management method, system and program are provided for bookmarking subsets of electronic mail (email) message content for subsequent searching and retrieval. In selected embodiments of the invention, subsets of email message content are designated through user gesture, such as using a mouse in a click and drag operation. The designated content is then identified through similar user gestures to be bookmarked for subsequent searching and retrieval. Identification information such as file pointers and Uniform Resource Identifier (URI) links identifying the bookmarked email message content are generated and then indexed such that the bookmarked content can be searched.

A copy of the email message is then automatically and persistently stored in a predetermined location, such as a directory file structure. In one embodiment, the copy of the bookmarked email message persists if the original email message is deleted. The bookmarked email message content can subsequently be retrieved, either by browsing the copies of the stored email messages or by performing search operations comprising search terms and key words. In one embodiment of the invention, the entirety of the email message content is displayed, with a plurality of bookmarked subsets of the message content designated according to their respective display attributes. In another embodiment, a predetermined amount of adjacent email message content that is not bookmarked is displayed. The above, as well as additional purposes, features, and advantages of the present invention will become apparent in the following detailed written description.

### BRIEF DESCRIPTION OF THE DRAWINGS

Selected embodiments of the present invention may be understood, and its numerous objects, features and advantages obtained, when the following detailed description is considered in conjunction with the following drawings, in which:

FIG. 1 depicts an exemplary client computer in which the present invention may be implemented;

FIG. 2 is a generalized flowchart illustrating the bookmarking of subsets of email message content for subsequent search and retrieval in accordance with an embodiment of the invention;

FIG. 3 is a generalized flowchart illustrating the search and retrieval of bookmarked subsets of email message content in accordance with an embodiment of the invention;

FIG. 4 is a generalized depiction of the user interface of an email client as implemented to bookmark subsets of email message content in accordance with an embodiment of the invention;

FIG. 5 is a generalized depiction of the user interface of an email client as implemented to browse bookmarked subsets of email message content in accordance with an embodiment of the invention;

FIG. 6 is a generalized depiction of the user interface of an email client as implemented to search for bookmarked subsets of email message content in accordance with an embodiment of the invention;

FIG. 7 is a generalized depiction of the user interface of an email client as implemented in accordance with an embodiment of the invention to display extracts of bookmarked subsets of email message content returned as a result of a search query; and

FIG. 8 is a generalized depiction of the user interface of an email client as implemented in accordance with an embodiment of the invention to display bookmarked subsets of email message content returned as a result of a search query.

### DETAILED DESCRIPTION

An email message content management method, system and program are disclosed for bookmarking subsets of electronic mail (email) message content for subsequent searching and retrieval. In selected embodiments of the invention, subsets of email message content are designated through user gesture, such as using a mouse in a click and drag operation. The designated content is then identified through similar user gestures to be bookmarked for subsequent searching and retrieval. Identification information such as file pointers and Uniform Resource Identifier (URI) links identifying the bookmarked email message content are generated and then indexed such that the bookmarked content can be searched. A copy of the email message is then automatically and persistently stored in a predetermined location, such as a directory file structure. The bookmarked email message content can subsequently be retrieved, either by browsing the copies of the stored email messages or by performing search operations comprising search terms and key words.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

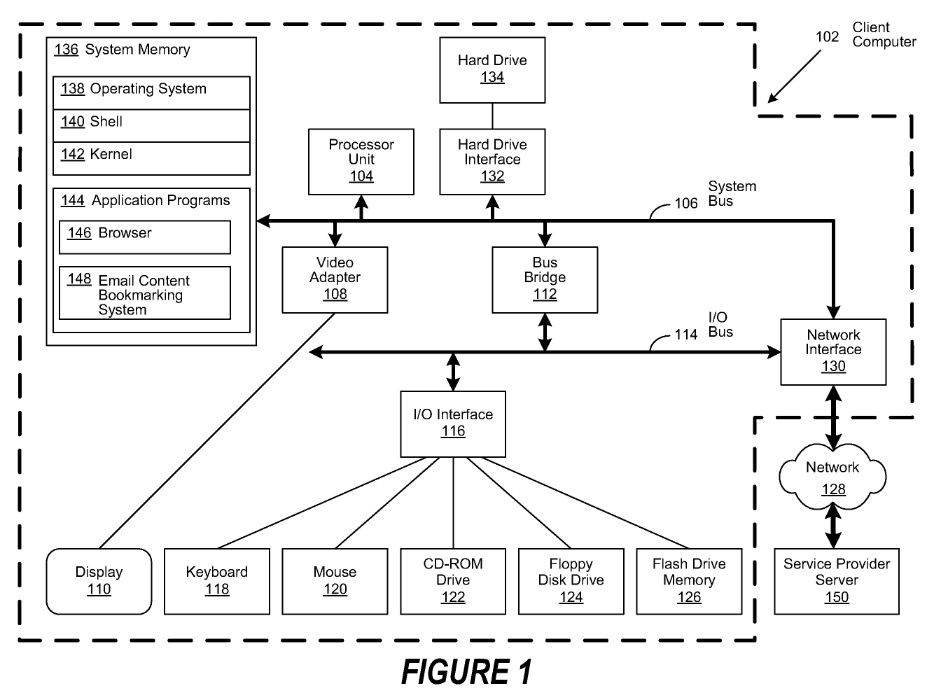

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 150 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 150.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140 for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and application programs 144, including memory management, process and task management, disk management, and mouse and keyboard management.

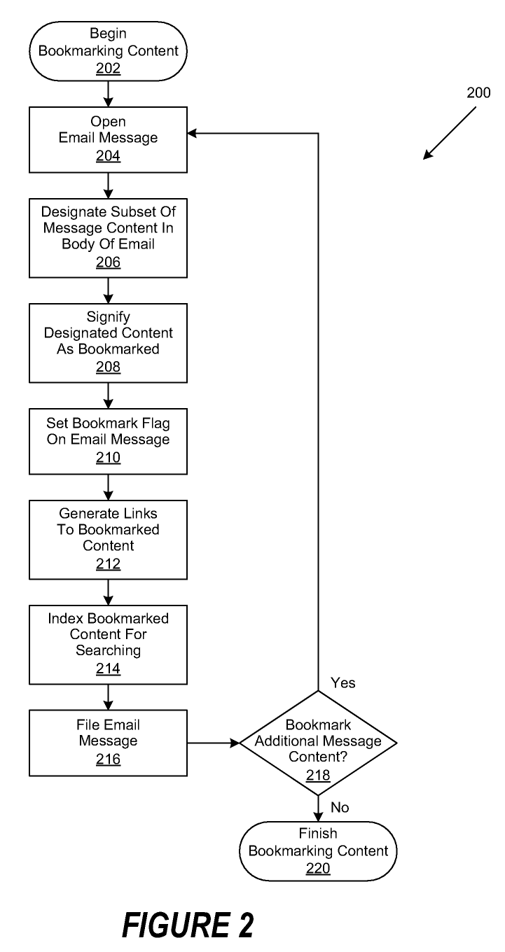

Application programs 144 may include an email client 146. Email client 146 includes program modules and instructions enabling email messages to be sent and received. Email client 146 also includes an email content bookmarking system 148. Email content bookmarking system 148 includes code for implementing the processes described in FIGS. 2-8 described hereinbelow. In one embodiment, client computer 102 is able to download email content bookmarking system 148 from a service provider server 150.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

FIG. 2 is a generalized flow chart illustrating the bookmarking of subsets of email message content 200 for subsequent search and retrieval in accordance with an embodiment of the invention. In selected embodiments, an email recipient begins bookmarking subsets of email message content in step 202 by logging on to an email client. The email recipient opens an email message in step 204 and performs user actions to accentuate one or more subsets of content comprising the email in step 206. In one embodiment, message content is designated through user gesture, such as using a mouse in a click and drag operation to accentuate the selection, which can be displayed as an outlined area within the sender's email client interface. In another embodiment, message content is designated in color, with the user having the option to select an accentuation color for each subset of email message content. In another embodiment, the designated content is underlined. In yet another embodiment, the designated content is text which changed to a bold typeface. Once designated, the email message content subset is then identified as being bookmarked for subsequent search and retrieval through similar user gestures in step 208. In one embodiment, a drop-down content attributes window is opened within the email client interface and the sender chooses an option for bookmarking the designated subset of email message content.

In another embodiment, the area comprising the bookmarked email message content comprises a predetermined amount of adjacent email message content that is not designated. For example, the paragraph comprising the designated content can comprise the bookmarked content. In this example, searches can be executed on the content comprising the designated content, with the non-designated content returned in the search results and displayed within the user's email client. In another embodiment, the predetermined amount of adjacent email message content that is not designated comprises the remaining email message content of the email message. In yet another embodiment, the email recipient can configure the email client to display a predetermined amount of adjacent, non-designated content when displaying bookmarked content. In still another embodiment, a plurality of bookmarked email message content subsets comprises the same email message.

Once the designated subsets of email message content are identified as being bookmarked, identification information such as a file pointer or flag is implemented in step 210 to signify the email message comprises bookmarked subsets of content for subsequent retrieval. In one embodiment, the identification information signifies that a copy of the bookmarked email message is to be automatically and persistently stored in a repository of similarly bookmarked email messages, even if the original email message is deleted. In another embodiment, the identification information signifies that the original email message, or a copy thereof, is to be automatically and persistently stored unless explicitly deleted by the user.

Links to the identification information comprising the bookmarked content subsets are then generated in step 212. In one embodiment, the link comprises one or more uniform resource identifiers (URI), whose function and operation are familiar to those of skill in the art. The identification information and their associated links are then indexed for subsequent searching in step 214 and the bookmarked email message is then stored in a predetermined location in 216. In one embodiment, the bookmarked email message is stored in a directory file structure. In another embodiment, the file structure comprises an email message content bookmark folder comprising stored email messages further comprising bookmarked subsets of email message content. In yet another embodiment, the email message content bookmark folder comprises a mirror image of a directory structure comprising email messages that do not comprise bookmarked email message content. If it is determined in step 218 that additional email message content is to be designated and bookmarked for subsequent searching and retrieval, the process is repeated beginning in step 204. Once all subsets of email message content are designated and respectively identified as being bookmarked for subsequent searching and retrieval, bookmarking operations are ended in step 220.

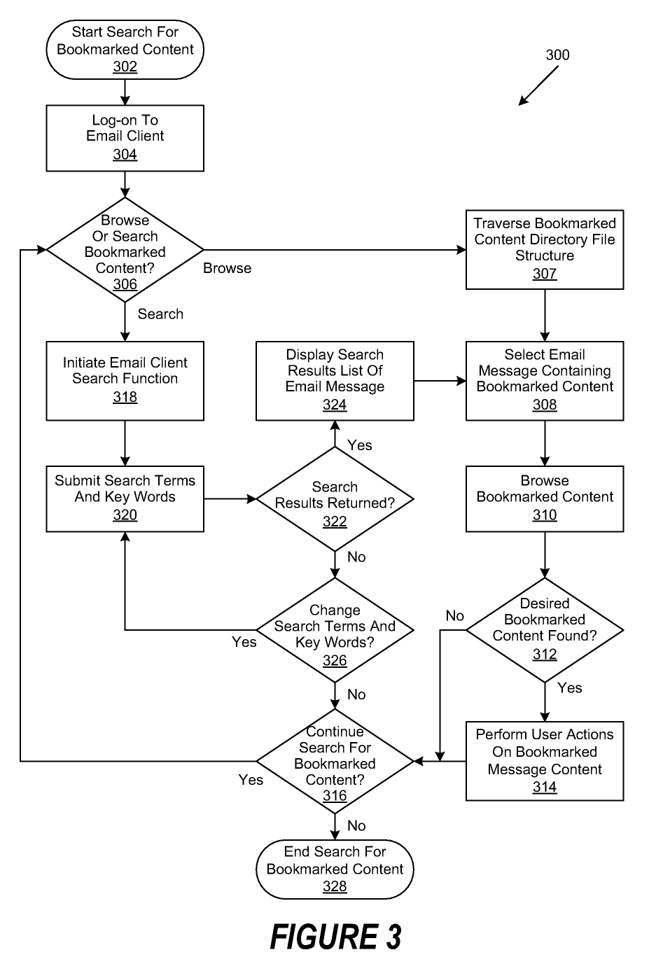

FIG. 3 is a generalized flow chart illustrating the search and retrieval of bookmarked subsets of email message content 300 in accordance with an embodiment of the invention. In selected embodiments, an email user begins the search and retrieval of bookmarked subsets of email messaging content in step 302 by logging onto an email client in step 304. If it is determined by the email user in step 306 to browse email messages comprising subsets of content that have been previously bookmarked and stored in a directory file structure, then the email client is used to traverse the file structure in step 307. The email user then selects an email message containing bookmarked subsets of content to be browsed in step 308. Bookmarked subsets of content comprising the email are then browsed in step 310 through user gestures such as a mouse double-click, right-click, or hover over the selected email message.

If the desired bookmarked content is not found in step 312, then the email user determines in step 316 whether to continue searching for bookmarked subsets of email message content to retrieve. If the email user decides to continue the search, then the process continues, beginning with step 306. Otherwise the search and retrieval of bookmarked subsets of email message content ends in step 328. If the desired bookmarked content is found in step 312, then user actions are performed on the bookmarked subsets of email message content in 314. For example, the bookmarked content can be copied into another email message or electronic document. As another example, the original email message containing the bookmarked content can be forwarded to one or more recipients with attached comments or other information. The email user then determines in step 316 whether to continue searching for bookmarked subsets of email message content to retrieve. If the email user decides to continue the search, then the process continues, beginning with step 306. Otherwise the search and retrieval of bookmarked subsets of email message content ends in step 328.

If it is determined by the email user in step 306 to search for email messages comprising subsets of content that have been previously bookmarked, then the email user initiates an email client search function in step 318. Search terms and key words are then submitted to the email client search function in step 320 as described in greater detail herein. If it is determined in step 322 that no search results are returned, then it is determined in step 326 whether to change the search terms and key words submitted to the email client search function. If it is determined that the search terms and key words are to be changed and resubmitted, then the process is repeated beginning with step 320. If it is determined to not change and resubmit the search terms and key words, then the email user then determines in step 316 whether to continue searching for bookmarked subsets of email message content to retrieve. If the email user decides to continue the search, then the process continues, beginning with step 306. Otherwise the search and retrieval of bookmarked subsets of email message content ends in step 328.

If it is determined in step 322 that the email client search function has returned search results comprising email messages containing bookmarked subsets of email message content, then a list of the search results are displayed in step 324. The email user then selects an email message containing bookmarked subsets of content to be browsed in step 308. Bookmarked subsets of content comprising the email are then browsed in step 310 through user gestures such as a mouse double-click, right-click, or hover over the selected email message. If the desired bookmarked content is not found in step 312, then the email user determines in step 316 whether to continue searching for bookmarked subsets of email message content to retrieve. If the email user decides to continue the search, then the process continues, beginning with step 306. Otherwise the search and retrieval of bookmarked subsets of email message content ends in step 328. If the desired bookmarked content is found in step 312, then user actions are performed on the bookmarked subsets of email message content in 314. For example, the bookmarked content can be copied into another email message or electronic document. As another example, the original email message containing the bookmarked content can be forwarded to one or more recipients with attached comments or other information. The email user then determines in step 316 whether to continue searching for bookmarked subsets of email message content to retrieve. If the email user decides to continue the search, then the process continues, beginning with step 306. Otherwise the search and retrieval of bookmarked subsets of email message content ends in step 328.

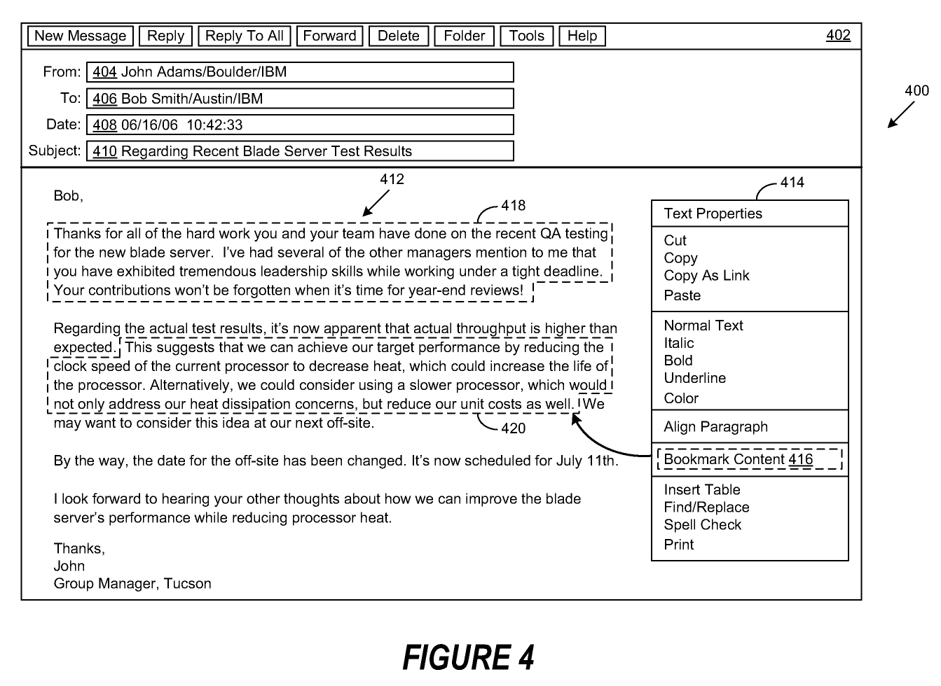

FIG. 4 is a generalized depiction of the user interface of an email client 402 as implemented to bookmark 400 subsets of email message content in accordance with an embodiment of the invention. In selected embodiments, an email user, typically the email recipient 406, uses email client 402 to view email message content comprising subject line 410 and date and time stamp 408 from sender 404. In an embodiment of the invention, the email user accentuates a first subset 418 and a second subset 420 of email message content 412 to generate bookmarks for their subsequent searching and retrieval. In one embodiment, message content to be designated is selected through user gesture, such as using a mouse in a click and drag operation to select the first and second content subsets 418, 420. In another embodiment, keyboard actions (e.g., <Alt> B, for “bookmarked”) are performed to mark the beginning and the end of the selected content. Once selected, the message content is designated by similar user gestures. In one embodiment, selected text is designated to be displayed as outlined text (e.g., a dashed line border surrounding the selected text) within the sender's email client interface. In another embodiment, selected text or other content is underlined. In yet another embodiment, selected text is designated in color. In still another embodiment, the user has the option to select a different accentuation color for each designated subset of content.

The designated content is then identified as a bookmark through similar user gestures. In one embodiment, a drop-down content attributes window 414 is opened within the email client interface and the sender chooses an option to bookmark content 416. Once the designated subsets of email message content are identified as being bookmarked, identification information such as a file pointer or flag is implemented as described in greater detail herein to signify the email message comprises bookmarked subsets of content for subsequent retrieval. As likewise described in greater detail herein, links to the identification information comprising the bookmarked content subsets are then generated. Once generated, the links and their associated identification information are then indexed for subsequent searching and the bookmarked email message is then stored in a predetermined location.

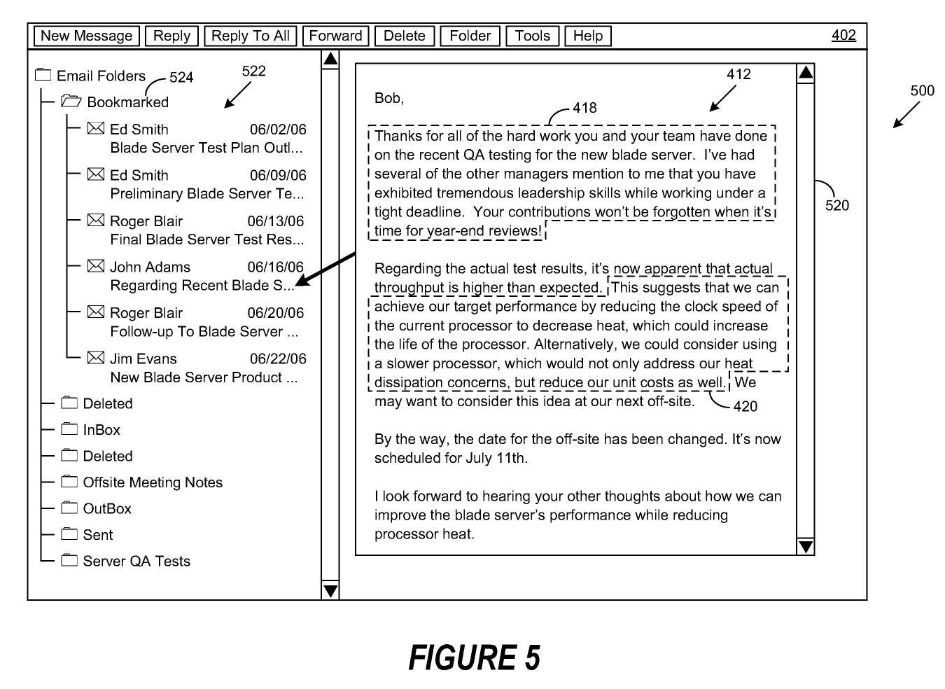

FIG. 5 is a generalized depiction of the user interface of an email client 402 as implemented to browse 500 bookmarked subsets of email message content in accordance with an embodiment of the invention. In selected embodiments, an email user, typically the email recipient, traverses the file directory structure 522 of email client 402 to select email messages comprising the bookmarked file folder 524. In these embodiments, the user can initiate email message browser 520 through user gesture such as a mouse double-click, right-click or hover over the selected email message to view bookmarked subsets 418, 420 of email message content 412. In one embodiment, each bookmarked subset 418, 420 of email message content 412 is displayed in a different color. In another embodiment, bookmarked subsets 418, 420 of email message content 412 are underlined. In yet another embodiment, bookmarked subsets 418, 420 of email message content 412 is displayed in a bold typeface.

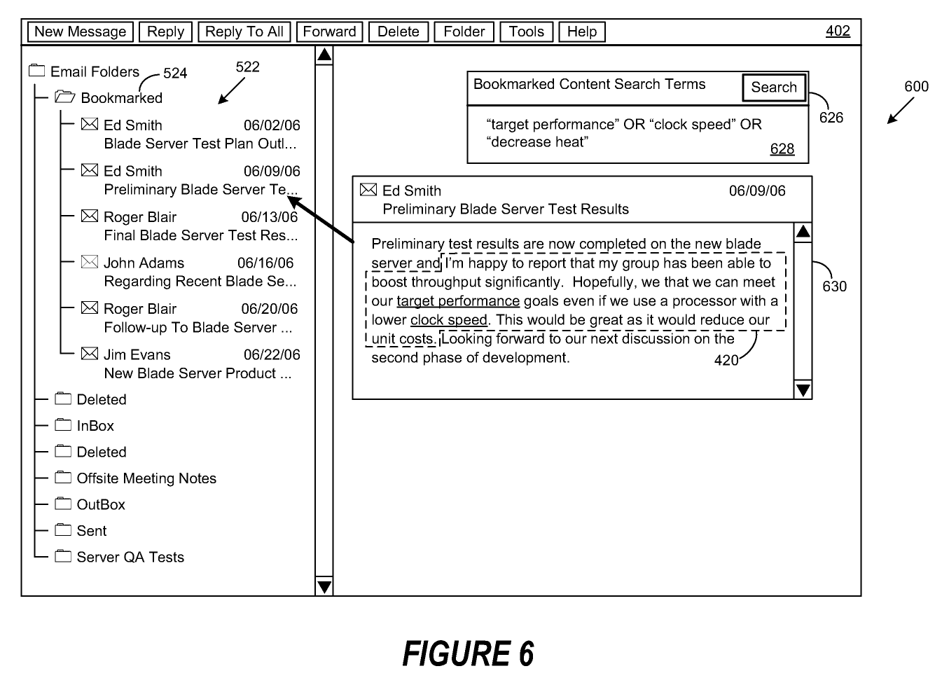

FIG. 6 is a generalized depiction of the user interface of an email client 402 as implemented to search 600 for bookmarked subsets of email message content in accordance with an embodiment of the invention. In selected embodiments, an email user, typically the email recipient, enters search terms and key words 628 into bookmarked content search function window 626. Email messages 522 containing bookmarked content are indicated in the bookmarked file folder comprising directory file structure 524.

In one embodiment, the user enters key words “target performance”, “clock speed” and “decrease heat”, each separated by a Boolean “OR” search term 628, in search function window 626. Email messages containing any of the entered key words are returned and displayed in the bookmarked file folder 522. In this embodiment, each of the email messages 522 comprises the sender, the send date and the subject line. The user initiates bookmarked content browser 630 through user gesture such as a mouse double-click, right-click or hover over the indicated email message. The bookmarked content browser 630 then displays the bookmarked subset 420 of email message content comprising the search terms and key words 628, which are underlined to further assist the user in identifying their presence within the bookmarked content by the user. In one embodiment, the bookmarked subset 420 of email message content comprising the search terms and key words 628 is displayed with a predetermined amount of additional message content that is not bookmarked. In another embodiment, the bookmarked subset 420 of email message content comprising the search terms and key words 628 is displayed with the remaining content of the email message that is not bookmarked. In yet another embodiment, the bookmarked subset 420 of email message content comprising the search terms and key words 628 is displayed with other bookmarked subsets of email message content comprising the same email message.

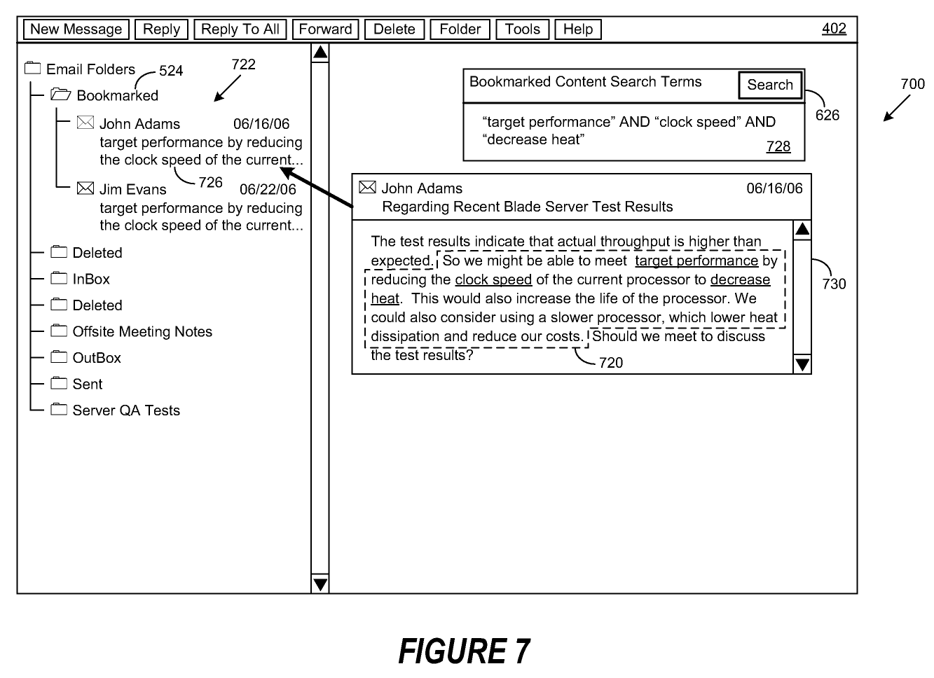

FIG. 7 is a generalized depiction of the user interface of an email client 402 as implemented in accordance with an embodiment of the invention to display extracts of bookmarked subsets of email message content 700 returned as a result of a search query. In selected embodiments, an email user, typically the email recipient, enters key words and search terms 728 into bookmarked content search function window 626. Email messages 722 containing bookmarked content comprising the key words and search terms 728 are indicated in the bookmarked file folder comprising directory file structure 524.

In one embodiment, the user enters key words “target performance”, “clock speed” and “decrease heat”, each separated by a Boolean “AND” search term 628, in search function window 626. Email messages 722 containing all of the entered key words are returned and displayed in the bookmarked file folder. In this embodiment, each of the email messages 722 comprising the bookmarked content directory 524 further comprise the sender, the send date and an extracted subset 726 of the bookmarked subset 720 of email message content comprising the key words and search terms 728. In another embodiment, the displayed subset 726 of bookmarked content begins with the first key words 728 entered into bookmarked content search function window 626.

In these embodiments, the user initiates bookmarked content browser 730 through user gesture such as a mouse double-click, right-click or hover over the indicated email message. The bookmarked content browser 730 then displays the bookmarked subset 720 of email message content comprising the search terms and key words 728, which are underlined to further assist the user in identifying their presence within the bookmarked content by the user. In one embodiment, the bookmarked subset 720 of email message content comprising the search terms and key words 728 is displayed with a predetermined amount of additional message content that is not bookmarked. In another embodiment, the bookmarked subset 720 of email message content comprising the search terms and key words 728 is displayed with the remaining content of the email message that is not bookmarked. In yet another embodiment, the bookmarked subset 720 of email message content comprising the search terms and key words 728 is displayed with other bookmarked subsets of email message content comprising the same email message.

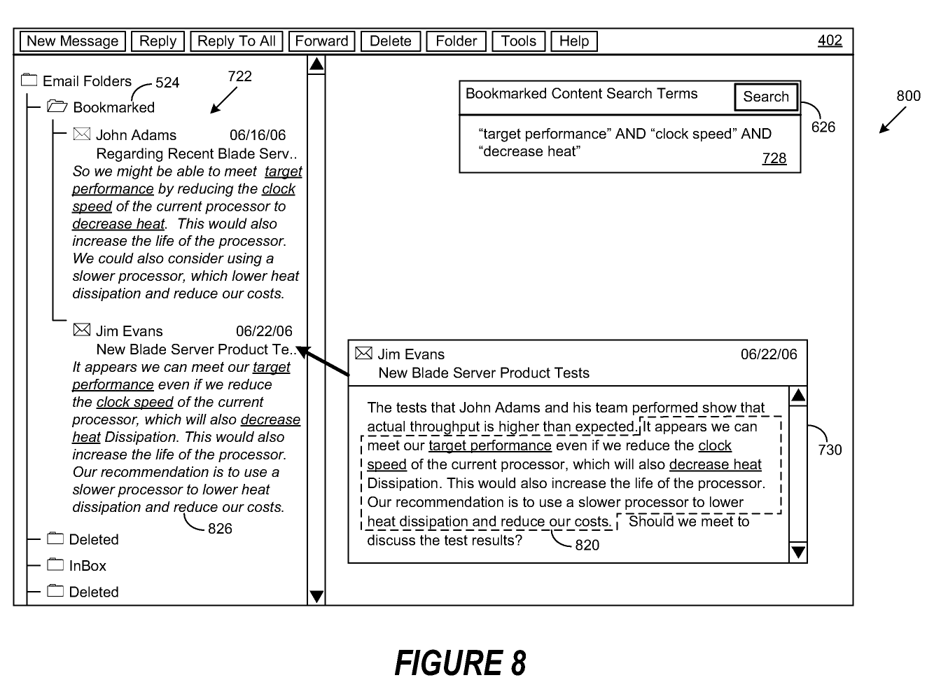

FIG. 8 is a generalized depiction of the user interface of an email client 402 as implemented in accordance with an embodiment of the invention to display bookmarked subsets of email message content 800 returned as a result of a search query. In selected embodiments, an email user, typically the email recipient, enters key words and search terms 728 into bookmarked content search function window 626. Email messages 722 containing bookmarked content comprising the key words and search terms 728 are indicated in the bookmarked file folder comprising directory file structure 524.

In one embodiment, the user enters key words “target performance”, “clock speed” and “decrease heat”, each separated by a Boolean “AND” search term 628, in search function window 626. Email messages 722 containing all of the entered key words are returned and displayed in the bookmarked file folder. In this embodiment, each of the email messages 722 comprising the bookmarked content directory 524 further comprise the sender, the send date, the subject line, and the bookmarked subset of email content 826. The bookmarked subset of email content 826 corresponds to the bookmarked subset 820 of email message content displayed in bookmarked content browser 730. The displayed subset 826 of bookmarked content is displayed in italicized text to indicate that it comprises bookmarked content.

In these embodiments, the user initiates bookmarked content browser 730 through user gesture such as a mouse double-click, right-click or hover over the indicated email message. The bookmarked content browser 730 then displays the bookmarked subset 720 of email message content comprising the search terms and key words 728, which are underlined to further assist the user in identifying their presence within the bookmarked content by the user. In one embodiment, the bookmarked subset 820 of email message content comprising the search terms and key words 728 is displayed with a predetermined amount of additional message content that is not bookmarked. In another embodiment, the bookmarked subset 820 of email message content comprising the search terms and key words 728 is displayed with the remaining content of the email message that is not bookmarked. In yet another embodiment, the bookmarked subset 820 of email message content comprising the search terms and key words 728 is displayed with other bookmarked subsets of email message content comprising the same email message.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A computer-implementable method of retrieving subsets of content in a plurality of electronic mail messages, comprising:
designating a subset of email message content for subsequent retrieval;
generating identification information correlatable with the designated subset of email message content;
storing the designated subset of email message content and identification information;
subsequently searching the identification information with a plurality of user-defined search terms, wherein the plurality of user-defined search terms identify the designated subset of email message content; and
using said identification information to retrieve said designated subset of email message content.

2. The method of claim 1, wherein the designated subset of email message content that is retrieved comprises a predetermined amount of adjacent email message content that is not designated.

3. The method of claim 1, wherein a plurality of designated subsets of email message content are contained in the same email message.

4. The method of claim 1, wherein the identification information comprises at least one file pointer.

5. The method of claim 1, wherein the identification information comprises at least one uniform resource identifier (URI).

6. The method of claim 1, wherein the designated subset of email message content is stored in a directory file structure.

7. A system comprising:
a processor;
a data bus coupled to the processor; and
a computer-usable medium embodying computer program code, the computer-usable medium being coupled to the data bus, the computer program code for mapping a plurality of received electronic mail (email) messages to a plurality of predetermined graphical representations of an email Inbox and comprising instructions executable by the processor and configured for:
designating a subset of email message content for subsequent retrieval;
generating identification information correlatable with the designated subset of email message content;
storing the designated subset of email message content and identification information;
subsequently searching the identification information with a plurality of user-defined search terms, wherein the plurality of user-defined search terms identify the designated subset of email message content; and
using said identification information to retrieve said designated subset of email message content.

8. The system of claim 7, wherein the designated subset of email message content that is retrieved comprises a predetermined amount of adjacent email message content that is not designated.

9. The system of claim 7, wherein a plurality of designated subsets of email message content are contained in the same email message.

10. The system of claim 7, wherein the identification information comprises at least one file pointer.

11. The system of claim 7, wherein the identification information comprises at least one uniform resource identifier (URI).

12. The system of claim 7, wherein the designated subset of email message content is stored in a directory file structure.

13. A computer-usable medium embodying computer program code, the computer program code comprising computer executable instructions configured for:
designating a subset of email message content for subsequent retrieval;
generating identification information correlatable with the designated subset of email message content;
storing the designated subset of email message content and identification information;
subsequently searching the identification information with a plurality of user-defined search terms, wherein the plurality of user-defined search terms identify the designated subset of email message content; and
using said identification information to retrieve said designated subset of email message content.

14. The computer-usable medium of claim 13, wherein the designated subset of email message content that is retrieved comprises a predetermined amount of adjacent email message content that is not designated.

15. The computer-usable medium of claim 13, wherein a plurality of designated subsets of email message content are contained in the same email message.

16. The computer-usable medium of claim 13, wherein the identification information comprises at least one file pointer.

17. The computer-usable medium of claim 13, wherein the identification information comprises at least one uniform resource identifier (URI).

18. The computer-usable medium of claim 13, wherein the designated subset of email message content is stored in a directory file structure.

19. The computer usable medium of claim 13, wherein the computer executable instructions are deployable to a client computer from a server at a remote location.

20. The computer usable medium of claim 13, wherein the computer executable instructions are provided by a service provider to a customer on an on-demand basis.
